(19) United States
(12) Patent Application Publication
(10) Pub. No.: US 2025/0091423 A1
(43) Pub. Date: Mar. 20, 2025

(54) VEHICLE FLOOR SHEET METAL ARRANGEMENT

(71) Applicant: BENTELER AUTOMOBILTECHNIK GMBH, Paderborn (DE)

(72) Inventors: Georg FROST, Steinheim (DE); Christian HIELSCHER, Delbrueck (DE); Andreas HITZ, Erwitte (DE); Paul KAUPMANN, Anroechte (DE); Mathias LOHBERG, Altenbeken (DE); Joern TOELLE, Paderborn (DE)

(21) Appl. No.: 18/884,834

(22) Filed: Sep. 13, 2024

(30) Foreign Application Priority Data
Sep. 14, 2023 (DE) 102023124894.4

(51) Int. Cl. B60K 1/04; B62D 25/20; B62D 29/00; H01M 50/249

(52) U.S. Cl. CPC B60K 1/04; B62D 25/20; B62D 29/00; H01M 50/249; H01M 2220/20

(57) ABSTRACT

The present disclosure relates to a vehicle floor sheet metal arrangement with a vehicle floor sheet metal as a component of a motor vehicle body having a flat floor and, on two opposite longitudinal sides and two opposite end sides, a downward deformation in relation to the vertical direction of the motor vehicle, such that a hood-like body is formed by the vehicle floor sheet metal, characterized in that the vehicle floor sheet metal is produced in one piece from a sheet-metal blank in one press stroke, and in that the vehicle floor sheet metal closes a battery box at the top in the vertical direction of the motor vehicle, the vehicle floor sheet metal optionally having regions with different tensile strength and/or different wall thickness.

### RELATED APPLICATIONS

The present application claims priority of German Application Number 10 2023 124 894.4 filed Sep. 14, 2023, the disclosure of which is hereby incorporated by reference herein in its entirety.

### FIELD

The present disclosure relates to a vehicle floor sheet metal arrangement, having a vehicle floor sheet metal for installation in or as a component of a motor vehicle body.

### BACKGROUND

Motor vehicle bodies are used in motor vehicles, for example, passenger vehicles. The passenger vehicles are driven by a combustion engine drive, but also by an electric drive.

Such a self-supporting body is made of individual sheet metal components produced by forming. These sheet metal components are mostly made of steel sheet alloys, but in other cases also of aluminum components. For this purpose, individual components, such as an A-pillar, a B-pillar, a C-pillar, various longitudinal members or cross members, are produced individually and then joined together by welding to form the self-supporting body.

Hot forming and press curing technology is also used for individual components. This allows for tensile strengths of more than 1,000 MPa in a curable steel alloy.

### SUMMARY

The object of the present disclosure is to provide a vehicle floor sheet metal able to be manufactured in a way that is simple in terms of production technology and also cost-effective in terms of its manufacturing costs, that has improved geometric precision and that has various connection options for additional components as well as a specific setting of crash properties.

The vehicle floor sheet metal arrangement includes a vehicle floor sheet metal as part of a motor vehicle body. In at least one embodiment of the present disclosure, a vehicle floor sheet metal is produced in a single piece by forming and then inserted into a self-supporting motor vehicle body. The vehicle floor sheet metal has a flat floor and a deformation on two opposite longitudinal sides and two opposite end sides. The deformation refers to the motor vehicle vertical direction downwards, which is also able to be referred to as a deformed edge or a peripheral edge. This results in a hood-like body or a hood-like tray. This hood-like body forms the vehicle floor sheet metal. The opening of the hood-like body is directed downwards in the vertical direction of the motor vehicle when installed in the motor vehicle body. Thus, with regard to the possible functional integration, the present disclosure achieves that the vehicle floor sheet metal, which forms the floor or the lower end of the passenger compartment, simultaneously also forms an upper hood of an electrical energy storage or a drive battery. The vehicle floor sheet metal thus also forms the upper part or the upper hood of the battery box. In at least one embodiment of the present disclosure, the downward-facing deformation or the edge is provided with a flange so that the lower part of a battery box is able to be coupled thereto.

At the same time, the vehicle floor sheet metal is produced in a single piece from a sheet metal blank in a single press stroke on a large press. The vehicle floor sheet metal has regions with different tensile strengths and/or different wall thicknesses. This measure is able to be used to provide higher strength in locally required regions, for example, by means of a higher wall thickness, or even higher strength when using the hot forming and press hardening technique of tailored tempering, which also increases tensile strength. The regions with higher strength have a tensile strength of more than 1,000 MPa, more than 1,350 MPa, more than 1,500 MPa, more than 1,800 MPa, or more than 2,000 MPa.

In at least one embodiment of the present disclosure, reinforce regions are able to have special connection strengths, for example, a molded cross member running transversely to the direction of travel, which also serves as a seat cross member. At the same time, this also serves to stiffen the manufactured vehicle body and to reinforce the passenger compartment, for example, in the event of a side impact. Such a cross member then has a high tensile strength and/or increased wall thickness locally over its length, wherein the length extension is oriented in the transverse direction of the motor vehicle.

In at least one embodiment of the present disclosure, “single piece” means that a sheet metal blank is used. The sheet metal blank itself is able to be a single piece and made of a single material. However, the sheet metal blank is also able to be provided as a tailored rolled blank or a tailored welded blank. In the latter case, and also in the case of a tailored welded blank, locally varying wall thicknesses and/or locally varying material properties are able to be used in order to develop the desired strengths in targeted local regions. In the case of a tailored welded blank, the individual sheet metal layers are placed abutting against each other and welded, for example, laser welded. However, there is also able to be overlap regions, which are then spot welded, for example.

In at least one embodiment of the present disclosure, the sheet metal blank is then fully prepared before the actual forming process. The entire floor sheet metal is then produced using hot forming and press hardening technology in a single forming operation or a forming press and in a single press stroke. The floor sheet metal is able to be manufactured as a cold-formed component in several stages, including as a whole component in a forming press, which significantly increases geometric precision in the case of individual arrangements.

At the same time, additional components are able to be dispensed with, since otherwise longitudinal and cross members are used in the floor region of a motor vehicle body and then corresponding floor sheet metals are used only as closing sheet metals or inserted in between. The stiffening functions, for example of longitudinal and cross members, are able to be integrated into the floor sheet metal by means of corresponding indentations and/or locally fixed regions. At the same time, the functional integration of a hood of a battery box is also molded. The overall production effort for the motor vehicle body is thus also reduced due to the fact that various individual components do not have to be manufactured individually and then assembled.

The overall dimension of the floor sheet metal is therefore more than 80 cm×100 cm, or more than 100 cm×150 cm. The vehicle floor sheet metal extends in the transverse direction of the motor vehicle body from one sill to the opposite sill. In the longitudinal direction of the motor vehicle, the vehicle floor sheet metal extends from a front wall or fire wall in the front region of the motor vehicle to the seat support in the rear region of the motor vehicle.

The selecting of at least individual sheets, for example, in the case of a tailored welded blank, from the alloy specifications is listed below. This allows for the creation of appropriately ductile regions between 500 and 1,000 MPa, or 500 and 850 MPa, or even lower than 450 MPa. In the case of high-strength, higher-strength or ultra-high-strength regions, corresponding specifications of more than 1,000 MPa are set by applying hot forming and press hardening technology.

The steel grades used are able to be applied in the following examples. In at least one embodiment of the present disclosure, the, different steel grades are able to be combined in a tailored welded blank. Corresponding strength ranges for hard or soft regions or strong or ductile regions are able to be found in the table. All alloy components are provided in wt. %, with the addition of residual iron and impurities resulting from the smelting process to the respective curable steel alloy.

### BRIEF DESCRIPTION OF THE DRAWINGS

Further advantages, features, characteristics and aspects of the present disclosure are the subject of the following description. Various embodiments are shown in schematic figures. They serve to facilitate an understanding of the present disclosure, the figures being:

FIG. 1 shows a partial section of a motor vehicle body for a motor vehicle according to at least one embodiment of the present disclosure,

FIG. 2A-FIG. 2C show a plan view, a longitudinal section and a cross-sectional view of a vehicle floor sheet metal arrangement according to at least one embodiment of the present disclosure,

FIG. 3A-FIG. 3C show a further embodiment according to at least one embodiment of the present disclosure,

FIG. 4A-FIG. 4C show an alternative variant to FIG. 2A-FIG. 2C according to at least one embodiment of the present disclosure,

FIG. 5A-FIG. 5C show a further alternative variant to FIG. 4A-FIG. 4C according to at least one embodiment of the present disclosure, and

FIG. 6A-FIG. 6C show a further alternative variant according to at least one embodiment of the present disclosure.

### DETAILED DESCRIPTION

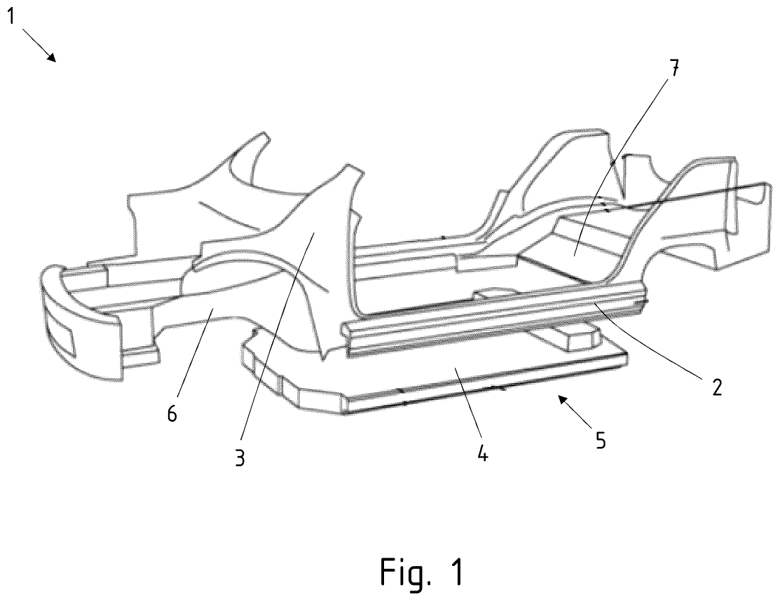

FIG. 1 shows a motor vehicle body 1 for a motor vehicle as a partial section. An A-pillar 3 at the front and a sill 2 are shown. A floor sheet metal 4 is attached below the motor vehicle body 1, so that a vehicle floor sheet metal arrangement 5 is thus obtained. Furthermore, opposing longitudinal members 6 are formed at the front and a rear seat support 7 is formed at the rear.

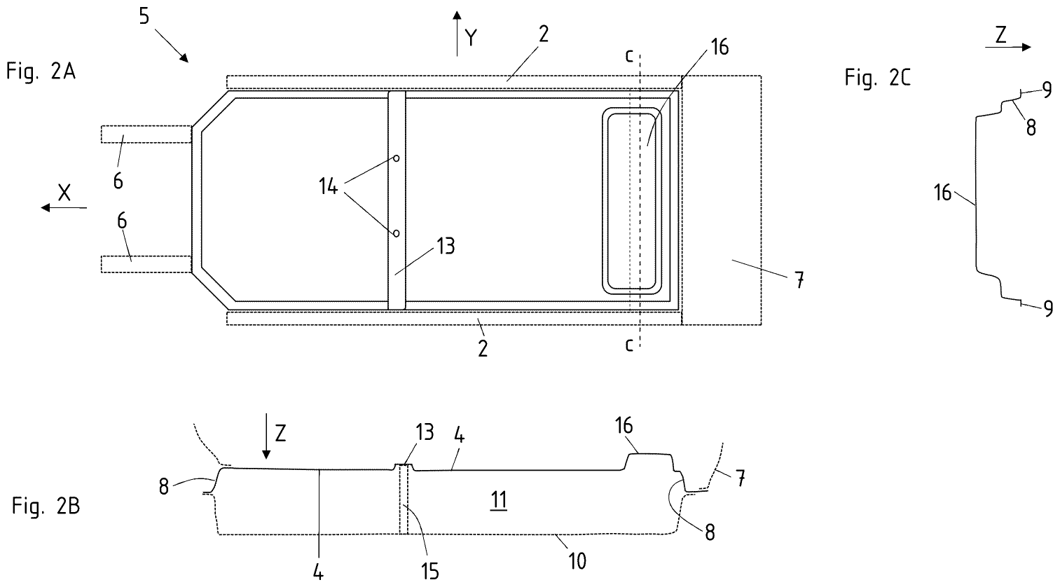

FIG. 2A-FIG. 2C show a top view, a longitudinal section and a cross-sectional view of a vehicle floor sheet metal arrangement 5 according to the present disclosure.

The vehicle floor sheet metal 4 according to the present disclosure has a peripheral frame or a deformation 8 all the way around, which is molded downwards in relation to the vertical direction Z of the vehicle, and is able to be designed as a peripheral frame 8. Opposite this, a peripheral flange 9 projects outwards for coupling to a lower shell or tray 10, so that a battery support 11 is formed overall. The vehicle floor sheet metal 4 thus forms the upper hood of the battery support 11, and extends over the entire vehicle floor, and, with reference to the transverse direction Y of the motor vehicle, from one sill 2 to the opposite sill 2, and, with reference to the longitudinal direction X of the motor vehicle, from a front wall or fire wall to the rear back-seat sheet metal. Furthermore, a cross member 13 is formed, which at the same time has receptacles 14 and is thus designed as a seat cross member. Sleeves 15 are able to extend below the receptacles 14. These sleeves 15 serve as stiffeners or spacers. In the rear region in the vertical direction, a hood-like trough 16 is then formed. This hood-like trough 16 is able to, for example, be used to accommodate power electronics, not shown in more detail, of the batteries, which are arranged in the battery support 11, but which is not shown in more detail here. In at least one embodiment of the present disclosure, a high-strength region is able to be formed, for example, in the region of the cross member or the transverse bead 13. Thus, sufficient rigidity in the transverse direction Y of the motor vehicle is achieved.

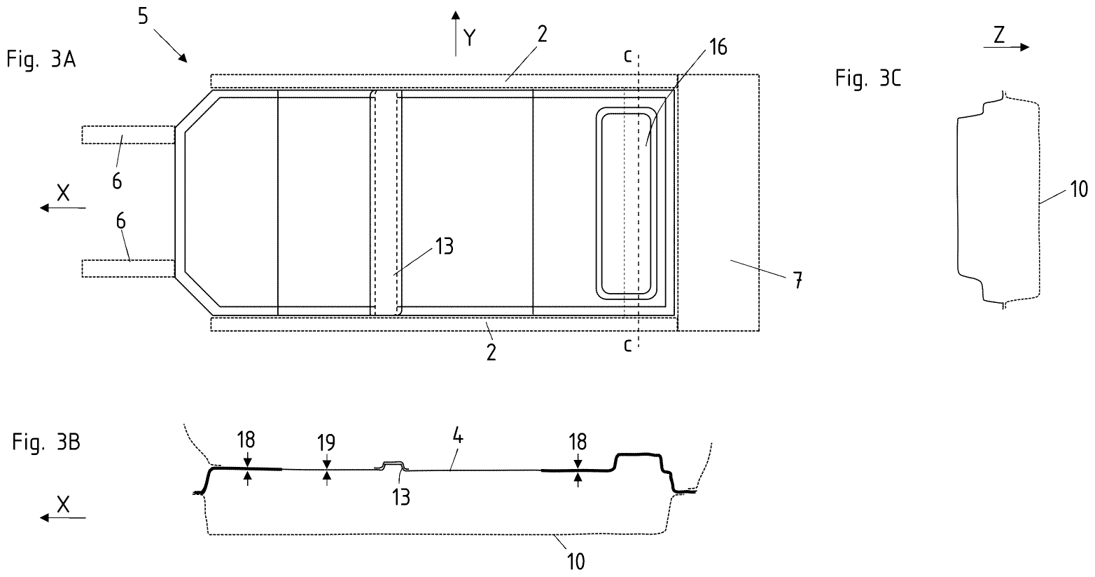

FIG. 3A-FIG. 3C show a further embodiment, taking into account either greater or lower wall thickness and/or increased or decreased tensile strength and/or the arrangement of a corresponding patch 17. In at least one embodiment of the present disclosure, a patch 17 is applied here in the region of the transverse bead 13, which reinforces the transverse bead 13. The entire vehicle floor sheet metal 4 is formed as a single-piece component. For this purpose, a sheet metal blank is initially provided as a tailored welded blank. In a front region in the longitudinal direction X of the motor vehicle, a greater wall thickness 18 is thus formed. Alternatively, a greater tensile strength is also able to be formed here. This is followed by a smaller wall thickness 19 or lower tensile strength. In a rear region, a greater wall thickness is then formed again, or alternatively or additionally, a greater tensile strength is able to be formed.

According to FIG. 3B, a thicker or greater wall thickness 18 is arranged in the front and rear region in the longitudinal direction of the motor vehicle. This serves for stiffening in the event of a head-on or rear-end crash. In the case of a seat cross member with a greater wall thickness 18, this increases the rigidity in the event of a side crash.

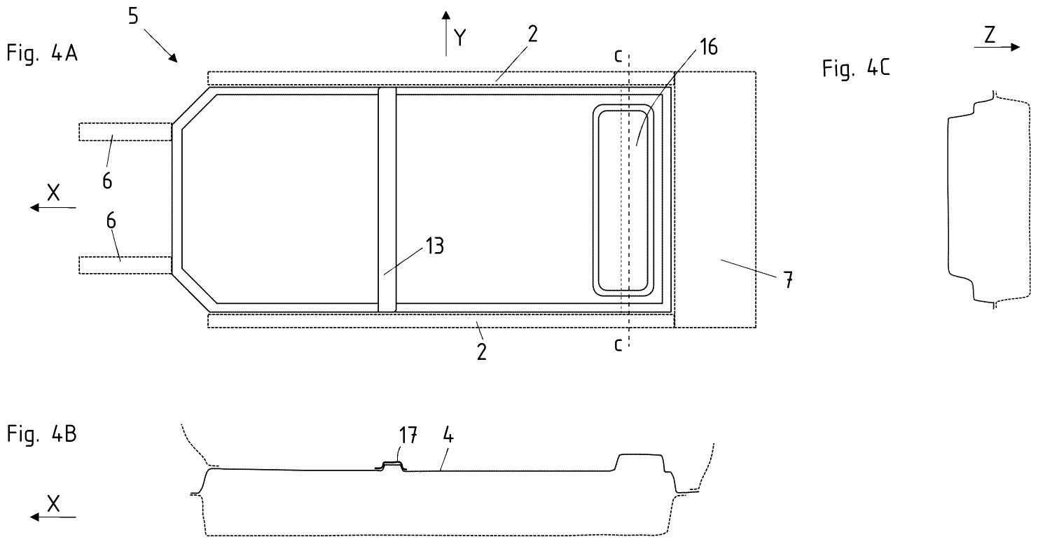

FIG. 4A-FIG. 4C show an alternative embodiment to FIG. 2A-FIG. 2C. Here, too, the transverse bead 13 is provided with a patch 17 that extends across the entire width of the motor vehicle in relation to the transverse direction Y of the motor vehicle.

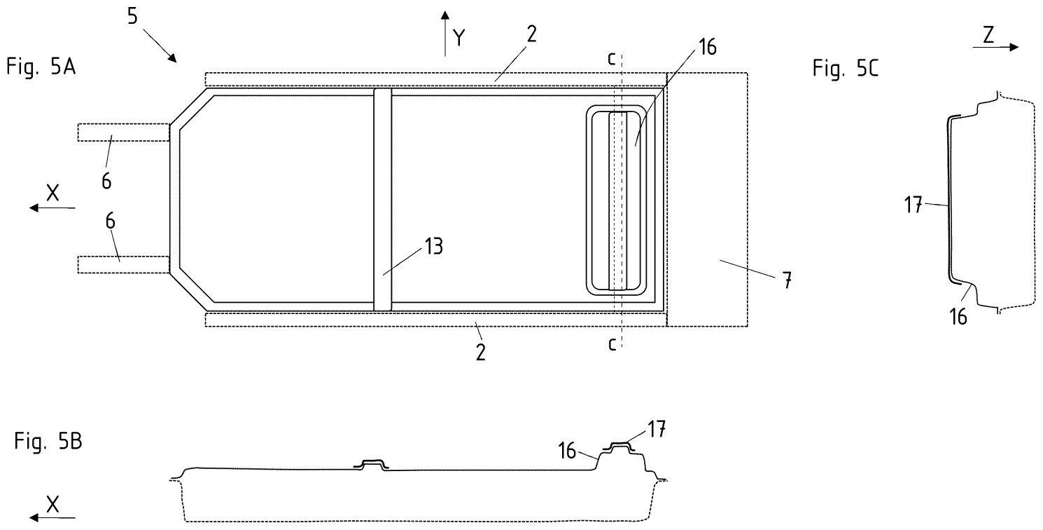

FIG. 5A-FIG. 5C show a further alternative embodiment variant to FIG. 4A-FIG. 4C. Here, a further patch 17 is placed in the rear region of the trough 16. This patch 17 also extends across the entire width of the motor vehicle, as shown in FIG. 5C.

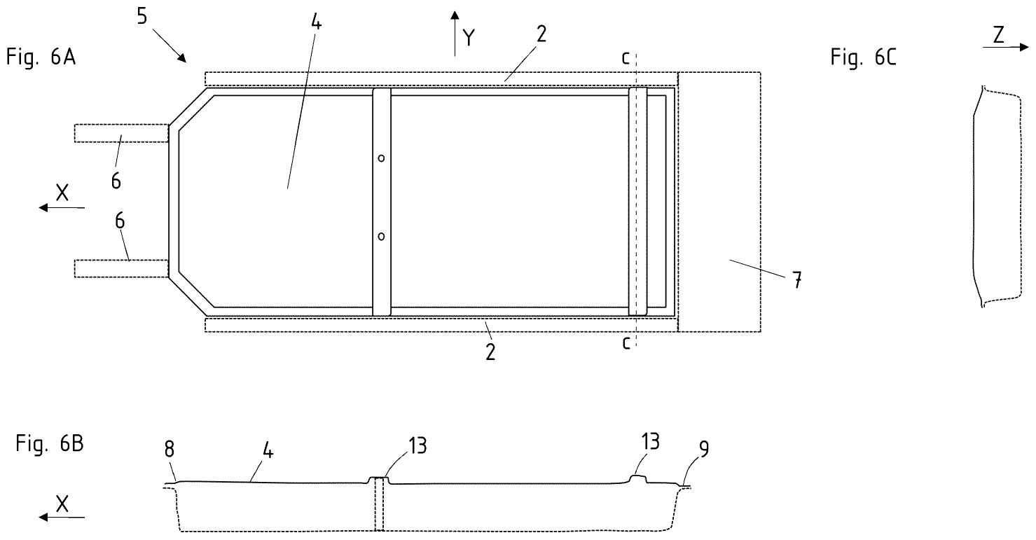

FIG. 6A-FIG. 6C show a further alternative embodiment. In this embodiment, the peripheral deformation 8 on the floor sheet metal 4 in the vehicle vertical direction Z is only slightly formed. This also has a peripheral flange. In the rear region, a second transverse bead is formed, which extends over the entire width of the floor sheet metal in the transverse direction of the motor vehicle.

The steel grades are able to be used subsequently as examples and for all variants of the present disclosure. In at least one embodiment of the present disclosure, different steel grades are able to be combined with one another in a tailored welded blank.

Corresponding strength ranges for hard or soft regions or strong or ductile regions are able to be found in the table. All alloy components are given in percent by weight, with the addition of residual iron and impurities caused by smelting to the respective curable steel alloy.

| 1 | TWB portion | C | | Si | | Mn | | P | | S | | Al | | B | | Cr | |
|---|---|---|---|---|---|---|---|---|---|---|---|---|---|---|---|---|---|
| 2 | made of | min | max | min | max | min | max | min | max | min | max | min | max | min | max | min | max |
| 3 | Curable steel Rm > | 0.19 | 0.25 | 0.1 | 0.4 | 1.1 | 1.4 | | 0.02 | | 0.005 | 0 | 0.06 | 0.001 | 0.005 | | 0.3 |
| | 1300 MPa | | | | | | | | | | | | | | | | |
| 4 | 22MnB5 Rm approx. | 0.2 | 0.23 | 0.2 | 0.3 | 1.1 | 1.4 | | 0.02 | | 0.006 | 0 | 0.06 | 0.002 | 0.004 | 0.1 | 0.3 |
| | 1500 MPa | | | | | | | | | | | | | | | | |
| 5 | Curable steel Rm > | 0.31 | 0.37 | 0.1 | 0.6 | 1 | 1.5 | | 0.025 | | 0.02 | | 0.1 | 0.001 | 0.004 | 0.06 | 0.35 |
| | 1750 MPa | | | | | | | | | | | | | | | | |
| 6 | 34MnB5 Rm approx. | 0.33 | 0.35 | 0.15 | 0.35 | 1 | 1.5 | | 0.025 | | 0.015 | 0.01 | 0.08 | 0.001 | 0.004 | 0.06 | 0.5-Mo |
| | 1900 MPa | | | | | | | | | | | | | | | | |
| 7 | Ductile steel > | 0.06 | 0.13 | | 0.7 | | 1.9 | | 0.05 | | 0.05 | | 0.1 | | 0.003 | | 0.15 |
| | 450 MPa | | | | | | | | | | | | | | | | |
| 8 | Curable ductile steel | 0.07 | 0.11 | 0.02 | 0.6 | 1.2 | 1.8 | | 0.03 | | 0.01 | 0.01 | 0.07 | 0.0007 | 0.002 | | 0.15 |
| | 800-1000 MPa | | | | | | | | | | | | | | | | |

| 1 | TWB portion | Cu | | N | | Nb | | Ni | | Ti | | V | | Mo | |
|---|---|---|---|---|---|---|---|---|---|---|---|---|---|---|---|
| 2 | made of | min | max | min | max | min | max | min | max | min | max | min | max | min | max |
| 3 | Curable steel Rm > | | 0.1 | | | | 0.05-Ti | 0.02 | 0.1 | 0.01 | 0.1 | | | | 0.35 |
| | 1300 MPa | | | | | | | | | | | | | | |
| 4 | 22MnB5 Rm approx. | | 0.1 | | 0.01 | | 0.05-Ti | 0.02 | 0.1 | 0.02 | 0.05 | | 0.01 | | 0.35 |
| | 1500 MPa | | | | | | | | | | | | | | |
| 5 | Curable steel Rm > | | 0.2 | | 0.2 | | 0.1 | | 0.2 | 0.002 | 0.05 | | | | 0.35 |
| | 1750 MPa | | | | | | | | | | | | | | |
| 6 | 34MnB5 Rm approx. | | 0.2 | | 0.2 | 0.01 | 0.05 | | 0.2 | 0.005 | 0.015 | | 0.01 | | 0.5-Cr |
| | 1900 MPa | | | | | | | | | | | | | | |
| 7 | Ductile steel > | | 0.2 | | 0.2 | | 0.1 | | | | 1.2 | | 0.1 | | 0.1 |
| | 450 MPa | | | | | | | | | | | | | | |
| 8 | Curable ductile steel | | 0.2 | | 0.2 | 0.04 | 0.1 | | | 0.03 | 0.2 | | 0.1 | | 0.1 |
| | 800-1000 MPa | | | | | | | | | | | | | | |

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-10. (canceled)

11. A vehicle floor sheet metal arrangement having a vehicle floor sheet metal as a component of a motor vehicle body, comprising:
a flat floor and, on two opposite longitudinal sides and two opposite end sides, a deformation directed downward relative to a vertical direction of the motor vehicle, such that a trough is formed by the vehicle floor sheet metal, wherein the vehicle floor sheet metal is one piece, and the vehicle floor sheet metal seals a battery box in an upward direction in the vertical direction of the motor vehicle.

12. The vehicle floor sheet metal arrangement according to claim 11, comprising a hot-formed and press-hardened component.

13. The vehicle floor sheet metal arrangement according to claim 11, wherein a high-strength region has a tensile strength greater than or equal to 1,350 MPa.

14. The vehicle floor sheet metal arrangement according to claim 11, wherein soft regions have a tensile strength Rm of less than 1,000 MPa.

15. The vehicle floor sheet metal arrangement according to claim 11, wherein the vehicle floor sheet metal extends from one sill to an opposite sill in a transverse direction of the vehicle.

16. The vehicle floor sheet metal arrangement according to claim 11, wherein the vehicle floor sheet metal has a peripheral flange for coupling to a lower shell of a battery box.

17. The vehicle floor sheet metal arrangement according to claim 11, wherein the trough is incorporated in a rear portion, with respect to the longitudinal direction of the motor vehicle, of the vehicle floor sheet metal, wherein power electronics or a cooling fluid pump of a drive battery are insertable in the trough.

18. The vehicle floor sheet metal arrangement according to claim 11, wherein at least one transverse bead is formed in the vehicle floor sheet metal, and the at least one transverse bead comprises a seat cross member.

19. The vehicle floor sheet metal arrangement according to claim 11, wherein footwell troughs are formed in a downward direction relative to the vertical direction of the motor vehicle.

20. The vehicle floor sheet metal arrangement according to claim 18, wherein a patch is applied to the at least one transverse bead and extends across an entire width of motor vehicle.

21. The vehicle floor sheet metal arrangement according to claim 11, wherein the vehicle floor sheet metal is formed in one press stroke.

22. The vehicle floor sheet metal arrangement according to claim 11, wherein the vehicle floor sheet metal has regions with different tensile strength and different wall thicknesses.

23. The vehicle floor sheet metal arrangement according to claim 11, wherein soft regions have a tensile strength Rm of less than 850 MPa.

24. The vehicle floor sheet metal arrangement according to claim 17, wherein the trough is incorporated by stamping.
